(19) United States
(12) Patent Application Publication
(10) Pub. No.: US 2024/0414496 A1
(43) Pub. Date: Dec. 12, 2024

(54) APPARATUS AND METHOD FOR HEAD-RELATED TRANSFER FUNCTION COMPRESSION

(71) Applicant: Fraunhofer-Gesellschaft zur Förderung der angewandten Forschung e.V., München (DE)

(72) Inventors: Felix WOLF, Erlangen (DE); Oliver SCHEUREGGER, Erlangen (DE); Simone NEUKAM, Erlangen (DE)

(73) Assignee: Fraunhofer-Gesellschaft zur Förderung der angewandten Forschung e.V., München (DE)

(21) Appl. No.: 18/808,058

(22) Filed: Aug. 18, 2024

Related U.S. Application Data
(63) Continuation of application No. PCT/EP2023/054103, filed on Feb. 17, 2023.

(30) Foreign Application Priority Data
Feb. 18, 2022 (EP) 22157510.3

(51) Int. Cl. H04S 7/00; H04S 1/00

(52) U.S. Cl. CPC H04S 7/307; H04S 1/007; H04S 7/302; H04S 2400/09; H04S 2400/11; H04S 2420/01

(57) ABSTRACT

An apparatus is provided. The apparatus comprises a rendering information processor configured for modifying, depending on direction information, original binaural rendering information to obtain modified binaural rendering information in which a spectral distortion is adjusted.

### CROSS-REFERENCES TO RELATED APPLICATIONS

This application is a continuation of copending International Application No. PCT/EP2023/054103, filed Mar. 17, 2023, which is incorporated herein by reference in its entirety, and additionally claims priority from European Application No. EP 22 157 510.3, filed Feb. 18, 2022, which is incorporated herein by reference in its entirety.

The present invention relates to audio signal encoding, audio signal processing and audio signal decoding, and, in particular, to an apparatus and method for binaural rendering, and, more particularly, to an apparatus and method for Head-Related Transfer Function (HRTF) compression and expansion.

### BACKGROUND OF THE INVENTION

When sound waves are emitted from loudspeakers to the ears of a listener, the sound is modified multiple times, e.g., by reflections of the sound waves at walls. By this, the sound that arrives at the pinna of the ear comprises, in addition to, e.g., music and speech, also information on the listening environment.

In addition thereto, sound arriving from multiple directions is formed by the head and the pinna of the listener in different ways. Using this information, the brain of the listener is capable to determine an approximated direction and distance of a sound source.

However, if a headphone is employed, usually, all such information is missing, as the audio is almost directly emitted on the eardrums of the listener. By this an impression is created as if the sound would be generated within the head of the listener which may be perceived as inconvenient, and, e.g., spectral coloration may, e.g., occur, in particular, when earphones are employed for a longer time.

It has been determined that the above-described modifications of the sound waves on their way to the pinna and eardrum of the listener can be measured and replicated by digital filters, for example, by employing head-related impulse responses, head-related transfer functions, binaural room impulse responses and binaural room transfer functions. If such filters are applied on audio signals that are to be reproduced by headphones or small earphones, spatial sound is created that creates a realistic sound impression. Such an audio signal processing is referred to as binaural processing or binaural rendering.

Head-Related Transfer Functions (HRTFs) are acoustical transfer functions from sound sources to two ears. HRTFs contain locational information of the corresponding sound sources. A virtual sound from a certain direction can be produced by a convolution of the corresponding HRTFs and an audio signal, when listened to via headphones.

In order to binaurally render spatial sound, HRTFs of the relevant locations around listener are measured and stored. The magnitudes of HRTFs are frequency-dependent and provide essential psychoacoustic cues for a plausible binaural effect. However, these variations across frequency necessarily result in spectral distortion of the audio signal after binauralisation.

The degree to which a signal is spectrally distorted will be more or less tolerable depending on a number of factors, for example, the type of input signal (e.g., speech, music, ambience, special effects, etc.), the frequency spectra of the signal, the frequency spectra of the HRTFs, whether or not dynamic head-tracking is used during binaural reproduction, and the distribution of the signals around the head.

The distortion of the signal can be reduced, if the magnitudes of the HRTFs are flattened over frequency. This flattening is henceforth referred to as HRTF compression. Analogously, enhancement of the spectral magnitudes can be achieved by the inverse-referred to as HRTF expansion, and will increase the spectral distortion of the input signal. To avoid redundancy, if in the following, reference is made to “HRTF compression”, given the understanding that “expansion” is simply “negative compression”, the term “HRTF compression” comprises HRTF compression and HRTF expansion. No algorithmic differences exist between compression and expansion.

There is a trade-off between using uncompressed HRTFs providing full cues for a plausible binaural rendering, but risking spectral distortion of the binaural audio signal, and, on the other hand, using compressed HRTFs providing less effective cues for plausible binaural rendering, but resulting in less spectral distortion of the binaural audio signal.

In [1] and [2], a modification of HRTF filters to reduce unwanted timbral effects is described. This technology also reduces the variation in the root-mean-square (RMS) spectrum of HRTFs to reduce unwanted timbral coloration.

In [3], an influence of magnitude compression or flattening on a perceptual outcome (e.g. externalization) is described.

In [4] and [5] concepts are provided for binaurally virtualizing a single-channel audio signal only partially by filtering. A control allows a smooth transition between a completely binaural virtualization based on HRTF and a non-binaural virtualization corresponding to panning.

In [6], [7] and [8] concepts are provided, which try to reduce spectral distortion in general, although such concepts appear to affect an overall spatial impression, and complex operations or transforms are required, such as a principle component analysis (PCA).

In [8] and [9] concepts are described that try to compress the HRTFs to reduce redundancy and to reduce the amount of data to be stored. An HRTF representation is stored/transmitted that needs less data space than the original data set. The HRTFs are restored before rendering and the parametrization and reconstruction process often also influences the HRTF magnitude spectrum, causing it to flatten. The concepts provided in [8] and [9] operate on a set of HRTFs as a whole, not treating HRTFs from specific angles differently and therefore do not provide direct control over the perceptual outcome.

It would be ideal to achieve excellent localisation and externalisation without distorting the spectra of the input signals (and thus preserving artistic intent).

### SUMMARY

An embodiment may have an apparatus, wherein the apparatus comprises: a rendering information processor configured for modifying, depending on direction information, original binaural rendering information to acquire modified binaural rendering information in which a spectral distortion is adjusted.

Another embodiment may have a method, wherein the method comprises: modifying, depending on direction information, original binaural rendering information to acquire modified binaural rendering information in which a spectral distortion is adjusted.

Another embodiment may have a non-transitory digital storage medium having a computer program stored thereon to perform the method comprising: modifying, depending on direction information, original binaural rendering information to acquire modified binaural rendering information in which a spectral distortion is adjusted, when said computer program is run by a computer.

An apparatus is provided. The apparatus comprises a rendering information processor configured for modifying, depending on direction information, original binaural rendering information to obtain modified binaural rendering information in which a spectral distortion is adjusted.

Moreover, a method is provided. The method comprises:
Modifying, depending on direction information, original binaural rendering information to obtain modified binaural rendering information in which a spectral distortion is adjusted.

Furthermore, a computer program for implementing the above-described method, when being executed on a computer or signal processor.

In contrast to some embodiments of the present invention, the concepts presented in [1] and [2] do not algorithmically adjust the amount of compression based on HRTF angles azimuth and elevation, and therefore flatten the HRTF magnitude spectra in the same amount in all directions. Moreover, the concepts of [1], [2] operate on HRTF pairs, using the joint RMS spectrum of the original left ear and right ear filters, while embodiments of the present invention employ single HRTF filters, and thus better preserves RMS differences between the ears. Moreover, embodiments provide now concepts that parametrically adjust compression by weighting the compression factor in multiple dimensions.

In contrast to some of the embodiments, [3] does not provide an algorithmic approach how to adjust the flattening to maintain good quality.

In contrast to some embodiments of the present invention, the concepts provided in [4] and [5] do not provide a parametric, frequency dependent compression approach, and do not provide an approach for an entire database of HRTFs.

According to embodiments, a spectral distortion in binaural rendering is adjusted.

In some embodiments, a spatial impression may, e.g., be taken into account.

According to some embodiments, one or more HRTFs may, e.g., be processed.

In some embodiments, the one or more HRTFs may, e.g., be processed in a frequency domain.

According to some embodiments, an HRTF magnitude spectrum may, e.g., be processed in the frequency domain.

In some embodiments, the HRTF magnitude spectra may, e.g., be compressed or expanded.

According to some embodiments, the HRTF magnitude spectra may, e.g., be parametrically compressed or expanded the HRTF magnitude spectra by taking one or more parameters into account.

In some embodiments, one of the one or more parameters may, e.g., be an elevation angle of one or more of the HRTFs.

According to some embodiments, one of the one or more parameters may, e.g., be an azimuth angle of one or more of the HRTFs.

In some embodiments, one of the one or more parameters may, e.g., be a frequency.

According to some embodiments, a special treatment of frontal sources may, e.g., be provided.

In some embodiments, an offset for a special treatment of frontal sources may, e.g., be provided.

Some embodiments provide HRTF dynamics compression which provides the means to compress the HRTF's spectral magnitudes in an azimuth-, elevation- and frequency-dependent manner, such that the cues in important regions can be preserved, while the magnitude of the HRTFs can be controlled at different angular regions to control spectral distortion and timbral coloration in the resulting binaural output signal.

According to some embodiments, smooth HRTF compression factors over angle (az, ele) and frequency are provided. The application of these factors to the HRTFs provides reduced spectral distortion while maintaining best possible spatial impression.

In embodiments, a timbral distortion of HRTFs may, e.g., be reduced by reducing their spectral dynamics (dependent on direction) while maintaining spatial impression.

Some embodiments may, e.g., operate only on the frequency magnitudes of the HRTFs, e.g., without modifying the phase.

Spectral peaks and notches are an integral component of any HRTF (especially elevated HRTFs) The peaks and notches are also unique to the specific direction of that HRTF (azimuth, elevation). The peaks and notches are an integral characteristic to synthesize binaural audio, however they will result in spectral distortion. Embodiments may, e.g., provide HRTF compression means to control the tradeoff between spectral distortion and spatial effect.

In an embodiment, a magnitude of each frequency bin may, e.g., be modified to be either closer (compression) or further away (expansion) from a root mean square of the magnitudes of the frequency bands of an HRTF.

According to some embodiments, an amount of compression applied to each HRTF is weighted depending on a azimuth angle, wherein frontal HRTFs may, e.g., get more compression, rear HRTFs get less, and/or depending on an elevation angle, wherein horizontal HRTFs may, e.g., get more compression, elevated get less

In an embodiment, an amount of compression may, e.g., be uniquely modified for a chosen angular focal region, e.g., for centre HRTFs where the azimuth is at, or is close to, 0.0.

According to an embodiment, different amounts of compression across different frequency regions may, e.g., be applied.

In embodiments, excellent localisation and externalisation is provided without distorting the spectra of the input signals (and thus preserving artistic intent), e.g., by employing HRTF dynamics compression according to an embodiment.

### BRIEF DESCRIPTION OF THE DRAWINGS

Embodiments of the present invention will be detailed subsequently referring to the appended drawings, in which:

FIG. 1 is an apparatus according to an embodiment.

FIG. 2 is an apparatus for binaural rendering according to an embodiment.

FIG. 3 illustrates a compression for different vsp_angle_factor values without an application of a center_offset according to an embodiment.

FIG. 4 illustrates an influence of the center_offset on an overall compression value according to an embodiment.

FIG. 5 illustrates an overall HRTF compression processing according to an embodiment.

### DETAILED DESCRIPTION OF THE INVENTION

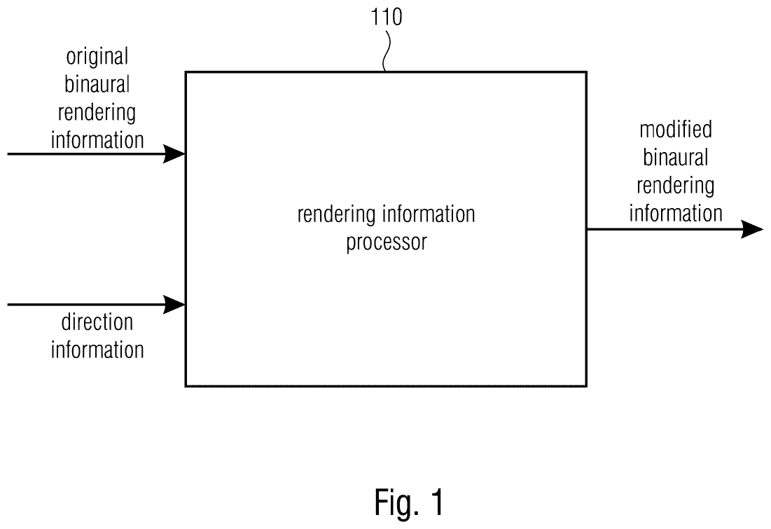

FIG. 1 illustrates an apparatus according to an embodiment.

The apparatus comprises a rendering information processor 110 configured for modifying, depending on direction information, original binaural rendering information to obtain modified binaural rendering information in which a spectral distortion is adjusted.

According to an embodiment, the rendering information processor 110 may, e.g., be configured to modify the original binaural rendering information such that a degree of an adjustment of the spectral distortion depends on the direction information.

In an embodiment, the binaural rendering information may, e.g., be suitable for being used to process one or more audio input signals to obtain a binaural signal comprising two audio channels.

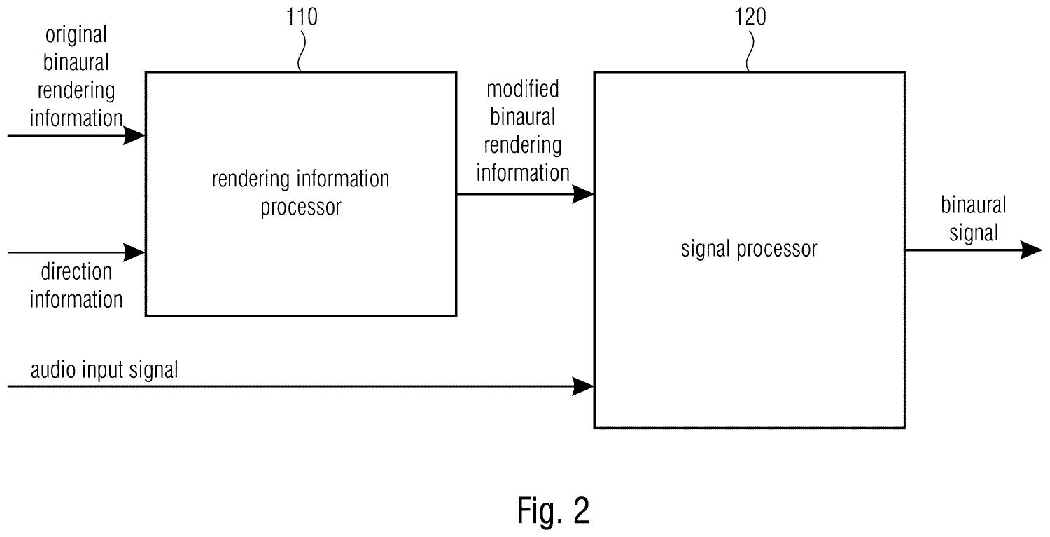

FIG. 2 illustrates an embodiment, wherein the apparatus further comprises a signal processor 120 configured for processing the one or more audio input signals depending on the modified binaural rendering information to obtain the binaural signal comprising the two audio channels.

According to an embodiment, the original binaural rendering information comprises one or more original head-related function pairs, wherein each of the one or more original head-related function pairs comprises a first original head-related function and a second original head-related function. Depending on the direction information, the rendering information processor 110 may, e.g., be configured to modify the first original head-related function and/or the second original head-related function of each of the one or more original head-related function pairs to obtain a first modified head-related function and/or a second modified head-related function of each of one or more modified head-related function pairs.

In an embodiment, the signal processor 120 may, e.g., be configured to processing the one or more audio input signals depending on at least one modified head-related function pair of the one or more modified head-related function pairs to obtain the binaural signal.

According to an embodiment, each of the first and second original head-related functions of each of the one or more original head-related function pairs and each of the first and second modified head-related functions of the one or more modified head-related function pairs may, e.g., be a head-related transfer function or may, e.g., be a head-related impulse response or may, e.g., be a binaural room transfer function or may, e.g., be a binaural room impulse response.

In an embodiment, the signal processor 120 may, e.g., comprise one or more audio filters for applying the first modified head-related function and/or the second modified head-related function of at least one of the one or more head-related function pairs on the audio input signal.

In an embodiment, the rendering information processor 110 may, e.g., be configured to process the first original head-related function and/or the second original head-related function of each of the one or more head-related function pairs in a frequency domain.

According to an embodiment, the rendering information processor 110 may, e.g., be configured to modify the first original head-related function and/or the second original head-related function of each original head-related function pair of the one or more head-related function pairs depending on the direction information such that a magnitude spectrum of the first original head-related function and/or a magnitude spectrum of the second original head-related function of said original head-related function pair may, e.g., be modified.

In an embodiment, the rendering information processor 110 may, e.g., be configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair may, e.g., be modified.

According to an embodiment, if the direction information indicates that spectral distortion shall be reduced, the rendering information processor 110 may, e.g., be configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair may, e.g., be reduced.

In an embodiment, the direction information may, e.g., comprise direction information for each of the one or more head-related function pairs.

According to an embodiment, the direction information for each of the one or more head-related function pairs comprises an elevation angle and/or an azimuth angle for said head-related function pair. The rendering information processor 110 may, e.g., be configured to modify the first original head-related function and/or the second original head-related function of said original head-related function pair depending on the elevation angle and/or depending on the azimuth angle for said head-related function pair.

In an embodiment, the rendering information processor 110 may, e.g., be configured to determine one or more modification parameters depending on the direction information. The rendering information processor 110 may, e.g., be configured to modify the first original head-related function and/or the second original head-related function of each of the one or more original head-related function pairs depending on the at least one of the one or more modification parameters. Each of the one or more modification parameters indicates the degree of the adjustment of the spectral distortion.

According to an embodiment, the rendering information processor 110 may, e.g., be configured to determine the one or more modification parameters by determining at least one modification parameter of the one or more modification parameters for each of the one or more head-related function pairs depending on the elevation angle and/or depending on the azimuth angle for said head-related function pair. Each of the modification parameter for said head-related function pair indicates the degree of the adjustment of the spectral distortion in the first modified head-related function and/or in the second modified head-related function of the modified head-related function pair compared to the spectral distortion in the first original head-related function and/or in the second original head-related function of the original head-related function pair.

In an embodiment, the rendering information processor 110 may, e.g., be configured to determine the at least one modification parameter for each of the one or more head-related function pairs depending on frequency.

According to an embodiment, the rendering information processor 110 may, e.g., be configured to generate the at least one modification parameter for each head-related function pair of the one or more head-related function pairs such that, if the azimuth angle of said head-related function pair indicates a presence of a frontal source, the modification parameter may, e.g., be generated in a different way for a same value of the elevation angle of said head-related function pair, compared to if the azimuth angle of said head-related function pair does not indicate a presence of a frontal source.

In an embodiment, the rendering information processor 110 may, e.g., be configured to generate the at least one modification parameter for each head-related function pair of the one or more head-related function pairs by generating an offset value that depends on the elevation angle of said head-related function pair, if the azimuth angle of said head-related function pair indicates the presence of the frontal source.

According to an embodiment, the one or more original head-related function pairs are a plurality of original head-related function pairs, wherein the direction information comprises different direction information for each of the plurality of head-related function pairs. The rendering information processor 110 may, e.g., be configured to modify the first original head-related function and/or the second original head-related function of each original head-related function pair of the plurality of original head-related function pairs depending on the direction information for said original head-related function pair to obtain a first modified head-related function and/or a second modified head-related function of each of the one or more modified head-related function pairs being a plurality modified head-related function pairs. The signal processor 120 may, e.g., be configured to process the one or more audio input signals depending on said at least one modified head-related function pair of the plurality of modified head-related function pairs to obtain the binaural signal.

In an embodiment, the signal processor 120 may, e.g., be configured to process the one or more audio input signals depending on one or more interpolated head-related function pairs to obtain the binaural signal. The rendering information processor 110 may, e.g., be configured to determine the interpolated head-related function comprising a first interpolated head-related function and a second interpolated head-related function. The rendering information processor 110 may, e.g., be configured to determine, depending on the direction information, the first interpolated head-related function by interpolating between the first head-related function of each of at least two head-related function pairs of the plurality of head-related function pairs. Moreover, the rendering information processor 110 may, e.g., be configured to determine, depending on the direction information, the second interpolated head-related function by interpolating between the second head-related function of each of the at least two head-related function pairs of the plurality of head-related function pairs.

In the following, particular embodiments are described.

When in the following, reference is made to head-related transfer functions, such a reference is to be understood as an example for a particular embodiment. The provided concepts are equally applicable with respect to the time domain for head-related impulse responses and are equally applicable for binaural room transfer functions and binaural room impulse responses. The term “head-related function” comprises head-related transfer function, head-related impulse response, binaural room transfer function and binaural room impulse response.

The measured HRTFs, for example, in the Quadrature Mirror Filter (QMF) domain, are considered as ‘uncompressed’. The most extreme version of HRTF compression would yield a flat line across all frequencies. In such an extreme version of HRTF compression, every QMF magnitude at all frequency bins would be equal to the root mean square (RMS) of the uncompressed HRTF.

According to some embodiments, an HRTF compression stage provides a way to move smoothly between these two states of ‘uncompressed’ and ‘fully compressed’, taking into account the possible directions of arrival of sound, i.e. azimuth and elevation angles around the listener's head.

In some embodiments, a modification parameter, for example, an azimuth- and elevation-dependent compression factor may, e.g., be calculated for each HRTF pair. In an embodiment, one compression factor for both left and right ears for a specific azimuth and elevation may, e.g., be calculated. This factor may, e.g., in an embodiment, further be weighted for each frequency band, e.g., for each QMF band. This factor may, e.g., then be applied to the corresponding frequency band of the corresponding HRTF. In another embodiment, two compression factors for the left and right ears for a specific azimuth and elevation may, e.g., be calculated.

According to an embodiment, the compression may, e.g., be applied parametrically, for example, dependent on the three parameters azimuth, elevation and frequency. In an embodiment, the compression may, for example, include the possibility to decrease compression specifically for specific angular focal regions (e.g., where the azimuth is equal to or close to) 0°. This provides flexible compression settings for directions where timbre-sensitive signals such as speech and vocals are typically positioned.

The provided concepts may, e.g., take the HRTF angles into account, for example, keeping the variations in an HRTF magnitude spectrum relatively high at angles considered very relevant for binaural rendering to maintain spatial cues. An advantage of some embodiments is that the concepts may, e.g., be highly customizable, such that a gradual change in compression, for example, as a function of azimuth, elevation and frequency may, e.g., be adjusted to best suit the input content and/or the binaural rendering intent.

In the following, a particular embodiment is provided.

A set of head-related transfer functions (HRTF) may, e.g., be taken as an input for the calculation of compression factors. A set of HRTFs may, e.g., be defined as multiple HRTFs for different combinations of azimuth and elevation angles.

The HRTFs may, e.g., be transferred to frequency domain using a QMF filter bank.

After that, a compression factor may, e.g., be calculated for each HRTF and each QMF-domain frequency band.

For example, for frequency band 1, the compression factor may, e.g., be constantly set to 1.0 for all HRTFs. For QMF bands 2 to 64 a loop is performed over all HRTFs and may, e.g., compute one compression factor per HRTF pair (left and right ear) per QMF band, for example, as defined in the following pseudo code:

```
% compression factor
hrtfComp_vspBaselineFactor = 1.0;
% angle-dependence for compression factor
hrtfComp_vspAzimuthFactor_anchor_horizontal = 0.25;
hrtfComp_vspAzimuthFactor_anchor_elevated = 0.05;
% centre offset
hrtfComp_centerOffset_anchor_horizontal = 0.10;
hrtfComp_centerOffset_anchor_elevated = 1.00;
% weight the compression factor dependent on the angle and elevation
compressionAngleFactor = cosd(abs(hrtf_elevations(i)));
compressionAngleFactor = (compressionAngleFactor − cosd(hrtfComp_el2compress)) * ...
        ((hrtfComp_vspAzimuthFactor_anchor_horizontal −
        hrtfComp_vspAzimuthFactor_anchor_elevated) / ...
          (1 − cosd(hrtfComp_el2compress))) +
          hrtfComp_vspAzimuthFactor_anchor_elevated;
compression2apply = hrtfComp_vspBaselineFactor *
abs(sind(hrtf_azimuths(i)/2)\hat{ }compressionAngleFactor);
% compute the weighting for the center (az=0)
if (hrtf_azimuths(i)==0)
  compressionCenterOffset = sind(abs(hrtf_elevations(i)));
  compressionCenterOffset = compressionCenterOffset * ...
            ((hrtfComp_centerOffset_anchor_elevated −
            hrtfComp_centerOffset_anchor_horizontal) / ...
            sind(hrtfComp_el2compress)) + hrtfComp_centerOffset_anchor_horizontal;
  compression2apply = compression2apply + compressionCenterOffset;
end
% compute RMS before compression over all frequencies
for e = 1:2% L/R ears
  input_rms(e) = rms( squeeze(hrtf(:, e, i)) );
  for b = 2:64% QMF bands
      % apply compression
    hrtf(b, e, i) = input_rms(e) + ( (hrtf(b, e, i) − input_rms(e)) * compression2apply);
  end
end
```

The resulting compression factor lies in the range between 0.0 (full compression) and 1.0 (no compression) for each HRTF and each band. It is dependent on three parameters:

The baseline compression is defined by the hrtfComp_vspBaselineFactor. This defines the overall upper limit of compression. This may, e.g., by default be set to 1.0 on a range between 0.0 (full compression) and 1.0 (no compression). Other values may, e.g., be used. For example, in another embodiment, 0 may, e.g., indicate full compression and 100 may, e.g., indicate no compression. In an embodiment, the baseline compression may, for example, set the upper limit of compression, and, e.g., compression may, e.g., usually be lower than this value as further azimuth and elevation weighting may, e.g., be applied.

The compressionAngleFactor defines an elevation-angle-dependent weighting. This is restricted by a compressionAngleFactor at elevation of 0°, defined by hrtfComp_vspAzimuthFactor_anchor_horizontal and a compressionAngleFactor at elevation 90° defined by hrtfComp_vspAzimuthFactor_anchor_elevated. Between +/−90° and 0° a cosine function may, e.g., be used to compute the intermediate values.

```
% angle-dependence for compression factor
hrtfComp_vspAzimuthFactor_anchor_horizontal = 0.25;
hrtfComp_vspAzimuthFactor_anchor_elevated = 0.05;
compressionAngleFactor = cosd(abs(hrtf_elevations(i)));
compressionAngleFactor = (compressionAngleFactor − cosd(hrtfComp_el2compress)) *
  ((hrtfComp_vspAzimuthFactor_anchor_horizontal −
  hrtfComp_vspAzimuthFactor_anchor_elevated) /
    (1 − cosd(hrtfComp_el2compress))) + hrtfComp_vspAzimuthFactor_anchor_elevated;
```

The compressionCenterOffset may, e.g., define an elevation-angle-dependent offset, which is applied in case the azimuth angle of the current HRTF is 0°. The compressionCenterOffset may, e.g., be smallest when elevation=0°. This ensures a compression factor close to 0.0, which corresponds to a high level of compression, and thus very clean timbre for important signals like speech. As elevation increases, the compressionCenterOffset is weighted, e.g., by a sine function, gradually increasing to a defined maximum. In case the azimuth is unequal to 0°, the compressionCenterOffset is set to 0.0.

```
% centre offset
hrtfComp_centerOffset_anchor_horizontal = 0.10;
hrtfComp_centerOffset_anchor_elevated = 1.00;
compressionCenterOffset = sind(abs(hrtf_elevations(i)));
compressionCenterOffset = compressionCenterOffset *
  ((hrtfComp_centerOffset_anchor_elevated −
  hrtfComp_centerOffset_anchor_horizontal) /
  sind(hrtfComp_el2compress)) + hrtfComp_centerOffset_anchor_horizontal;
```

In an embodiment, the compressionCenterOffset is applied, e.g., to avoid compression2apply being equal to 0.0 for azimuth==0°. Furthermore, the compressionCenterOffset is sine-weighted by elevation to also ensure that the total compression applied to center sources decreases as the elevation increases. A sine function may, e.g., be employed to compute a value between 0.0 and 1.0, for example, by applying a sine function sin (abs (elevation)) or similar. As a result, very clean timbre is preserved for horizontal center sources, but elevation and externalization cues are still preserved.

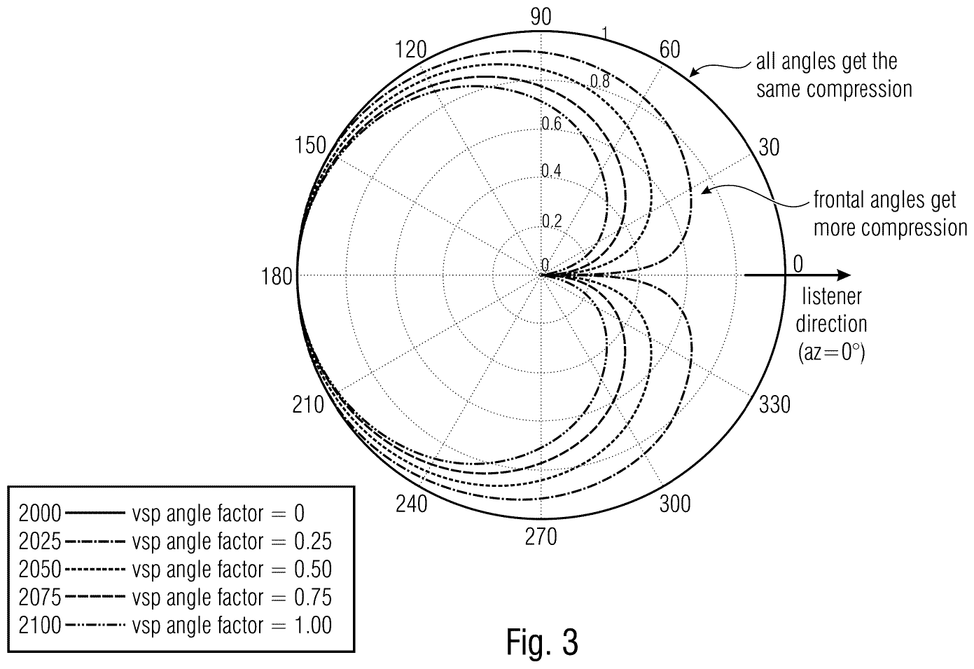

By applying the described algorithm, an angle-dependent band-wise compression factor is calculated. This is depicted in FIG. 3 for different compressionAngleFactor values before applying compressionCenterOffset.

In particular, FIG. 3 illustrates a compression for different compressionAngleFactor values without an application of a compressionCenterOffset according to an embodiment.

The plot represents the different compressionAngleFactor values (and therefore the different elevation angles). With a compressionAngleFactor being bigger than 0, the compression increases for front sources. In particular, compressionAngleFactor 0 is illustrated by line 2000, compressionAngleFactor 0.25 is illustrated by line 2025, compressionAngleFactor 0.5 is illustrated by line 2050, compressionAngleFactor 0.75 is illustrated by line 2075, and compressionAngleFactor 1 is illustrated by line 2100,

As the compressionAngleFactor increases, the compression increases for front sources (more heavily compressed).

Without compressionCenterOffset, for azimuth=0.0, a compression2apply=0.0 will always result. This may, e.g., be unwanted, as 100% compression will destroy all elevations cues and externalisation

In an embodiment, a compressionCenterOffset is applied to overcome this issue. For example, the compressionCenterOffset may, e.g., be smallest when elevation=0 to, e.g., achieve a very clean timbre for important signals like speech. As elevation increases, the compressionCenterOffset may, e.g., weighted by a sine function, and may, e.g., gradually increase to a maximum, e.g., to a maximum defined in the code.

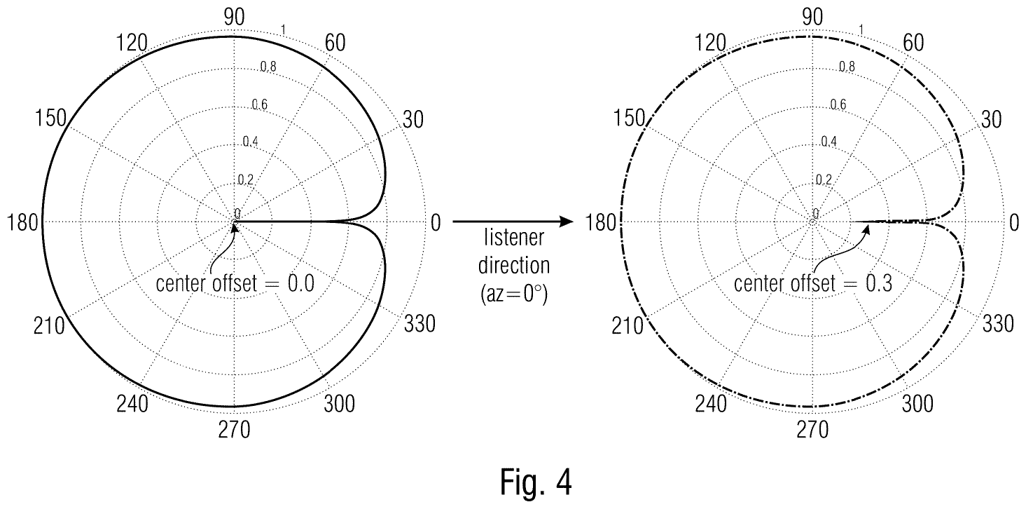

The effect of applying compressionCenterOffset is depicted in FIG. 4. In particular, FIG. 4 illustrates an influence of the compressionCenterOffset on an overall compression value according to an embodiment.

According to some embodiments, the final compression factor may, e.g., be applied to the HRTFs.

For example, the final compression factor may, e.g., be applied to the HRTFs by computing the RMS (root mean square) of the uncompressed HRTF, for example, for each single HRTF, by computing the RMS individually for left/right ears. This RMS values may, e.g., act as a pivot point across all frequencies. A flat line across frequency results. Computing the RMS individually for the left and right ears ensures that the overall ILDs (interaural level differences) are preserved after compression.

In the most extreme case (100% compression), all frequency bin magnitudes are set to the same RMS value (flat line across frequency), resulting in a passive downmix. This results in an effect very similar to vsp 0 processing (vsp=virtual speaker position), except that the original energy of the HRTF is preserved.

Then, for each QMF-domain frequency band, a weighted version (weighted with the corresponding band-wise compression factor) of the difference between the RMS and uncompressed HRTF's magnitude may, e.g., be added to the RMS. E.g., for each frequency, a weighted version of the difference between the RMS and uncompressed HRTF's magnitude may, e.g., be added to the RMS.

For example, the following formula may, e.g., be employed:

$$H R T {F}_{c o m p r e s s e d} ( az , ele , b ) = rms ( {HRTF}_{u n c o m p r e s s e d} ) ++ ( ( HRT {F}_{u n c o m p r e s s e d} ( az , ele , b ) - rms ( HRT {F}_{u n c o m p r e s s e d} ) ) \cdot \cdot compressionFactor ( az , ele , b ) )$$

for frequency bands b, b=0 . . . 63,
for all azimuths az,
for all elevations ele.
HRTF_{compressed} indicates a compressed HRTF.
HRTFin_{compressed} indicates an uncompressed HRTF.
rms indicates root mean square.

For example, compressionFactor (az,ele,0) may, e.g., always being equal to 0.25 across all azimuth and elevation angles.

This means when the compressionFactor is equal to 0.0 (full compression) the output HRTF may, e.g., be the RMS of the input HRTF. When the compressionFactor is, e.g., equal to 0.5 (50% compression), some of the uncompressed HRTF will be added back to the RMS in a frequency-dependent manner.

For example, in an embodiment, e.g., the rendering information processor 110 may, e.g., comprises a HRTF compression stage which provides means to move smoothly between these two states of ‘uncompressed’ and ‘fully compressed’, for example, by employing the above described formula for HRTF_{compressed} or by employing another formula.

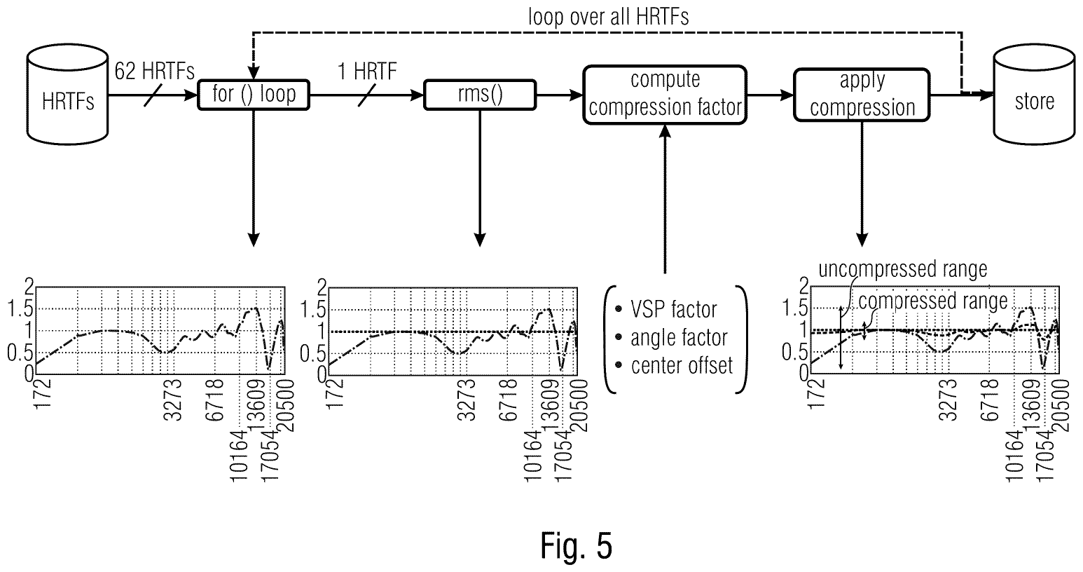

FIG. 5 illustrates an overall HRTF compression processing according to an embodiment.

In an embodiment, means are provided for individual (per user) HRTF personalization by employing the above-described concepts. According to an embodiment, different compression presets may, e.g., provided to users to select from. In an embodiment, users are enabled to individually tune the HRTF compression to their liking.

In the following, further embodiments are provided.

According to an embodiment, the compression may, e.g., be applied in a different frequency domain, e.g. in FFT domain instead of QMF domain.

In an embodiment, the processing of the lowest frequency band may, e.g., be conducted in a different way: For example, the dynamic algorithm could start to operate in band 0 instead of band 1. Or, a different pre-defined fixed compression value for the lowest band could be used.

According to an embodiment, the application of the angle-dependent compression factor may, e.g., be restricted to a different range of frequency bands (e.g., start at band 2 instead of band 1 or only run up to band 48).

In some embodiments, functions different than cosine or sine functions may, e.g., be employed, e.g., to define angle-dependent parameters, e.g. linear functions of quadratic functions.

According to an embodiment, an orientation of an angle-factor's weighting pattern may, e.g., be rotated such that high levels of compression are instead applied to the rear sources, while frontal sources are compressed very little.

In some embodiments, various amounts of compression across different frequency regions may, e.g., be employed, for example, to preserve elevation cues of elevated HRTFs at higher frequencies.

In the following, further embodiments are provided:

Embodiment 1: An apparatus, wherein the apparatus comprises:
a rendering information processor (110) configured for modifying, depending on direction information, original binaural rendering information to obtain modified binaural rendering information in which a spectral distortion is adjusted.

Embodiment 2: An apparatus according to embodiment 1,
wherein the rendering information processor (110) is configured to modify the original binaural rendering information such that a degree of an adjustment of the spectral distortion depends on the direction information.

Embodiment 3: An apparatus according to embodiment 1 or 2,
wherein the binaural rendering information is suitable for being used to process one or more audio input signals to obtain a binaural signal comprising two audio channels.

Embodiment 4: An apparatus according to embodiment 3,
wherein the apparatus further comprises a signal processor (120) configured for processing the one or more audio input signals depending on the modified binaural rendering information to obtain the binaural signal comprising the two audio channels.

Embodiment 5: An apparatus according to one of the preceding embodiments,
wherein the original binaural rendering information comprises one or more original head-related function pairs, wherein each of the one or more original head-related function pairs comprises a first original head-related function and a second original head-related function,
wherein, depending on the direction information, the rendering information processor (110) is configured to modify the first original head-related function and/or the second original head-related function of each of the one or more original head-related function pairs to obtain a first modified head-related function and/or a second modified head-related function of each of one or more modified head-related function pairs.

Embodiment 6: An apparatus according to embodiment 5,
wherein the rendering information processor (110) is configured to determine a factor depending on a direction, and
wherein the rendering information processor (110) is configured to apply the factor on the first original head-related function and/or on the second original head-related function of at least one of the one or more original head-related function pairs to obtain the first modified head-related function and/or the second modified head-related function of at least one of the one or more modified head-related function pairs.

Embodiment 7: An apparatus according to embodiment 6,
wherein the factor is a compression factor.

Embodiment 8: An apparatus according to one of embodiments 5 to 7, further depending on embodiment 4,
wherein the signal processor (120) is configured to process the one or more audio input signals depending on at least one modified head-related function pair of the one or more modified head-related function pairs to obtain the binaural signal.

Embodiment 9: An apparatus according to one of embodiments 5 to 8,
wherein each of the first and second original head-related functions of each of the one or more original head-related function pairs and each of the first and second modified head-related functions of the one or more modified head-related function pairs is a head-related transfer function or is a head-related impulse response or is a binaural room transfer function or is a binaural room impulse response.

Embodiment 10: An apparatus according to one of embodiments 5 to 9,
wherein the rendering information processor (110) is configured to process the first original head-related function and/or the second original head-related function of each of the one or more head-related function pairs in a frequency domain.

Embodiment 11: An apparatus according to one of embodiments 5 to 10,
wherein the rendering information processor (110) is configured to modify the first original head-related function and/or the second original head-related function of each original head-related function pair of the one or more head-related function pairs depending on the direction information such that a magnitude spectrum of the first original head-related function and/or a magnitude spectrum of the second original head-related function of said original head-related function pair is modified.

Embodiment 12: An apparatus according to one of embodiments 5 to 11,
wherein the rendering information processor (110) is configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair is modified.

Embodiment 13: An apparatus according to embodiment 12,
wherein, if the direction information indicates that spectral distortion shall be reduced, the rendering information processor (110) is configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair is reduced.

Embodiment 14: An apparatus according to one of embodiments 5 to 13,
wherein the direction information comprises direction information for each of the one or more head-related function pairs.

Embodiment 15: An apparatus according to embodiment 14,
wherein the direction information for each of the one or more head-related function pairs comprises an elevation angle and/or an azimuth angle for said head-related function pair, and
wherein the rendering information processor (110) is configured to modify the first original head-related function and/or the second original head-related function of said original head-related function pair depending on the elevation angle and/or depending on the azimuth angle for said head-related function pair.

Embodiment 16: An apparatus according to one of embodiments 5 to 15, further depending on embodiment 2,
wherein the rendering information processor (110) is configured to determine one or more modification parameters depending on the direction information,
wherein the rendering information processor (110) is configured to modify the first original head-related function and/or the second original head-related function of each of the one or more original head-related function pairs depending on the at least one of the one or more modification parameters,
wherein each of the one or more modification parameters indicates the degree of the adjustment of the spectral distortion.

Embodiment 17: An apparatus according to embodiment 16, further depending on embodiment 15,
wherein the rendering information processor (110) is configured to determine the one or more modification parameters by determining at least one modification parameter of the one or more modification parameters for each of the one or more head-related function pairs depending on the elevation angle and/or depending on the azimuth angle for said head-related function pair,
wherein each of the modification parameter for said head-related function pair indicates the degree of the adjustment of the spectral distortion in the first modified head-related function and/or in the second modified head-related function of the modified head-related function pair compared to the spectral distortion in the first original head-related function and/or in the second original head-related function of the original head-related function pair.

Embodiment 18: An apparatus according to embodiment 17,
wherein the rendering information processor (110) is configured to determine the at least one modification parameter for each of the one or more head-related function pairs depending on frequency.

Embodiment 19: An apparatus according to embodiment 17 or 18,
wherein the rendering information processor (110) is configured to generate the at least one modification parameter for each head-related function pair of the one or more head-related function pairs such that, if the azimuth angle of said head-related function pair indicates a presence of a frontal source, the modification parameter is generated in a different way for a same value of the elevation angle of said head-related function pair, compared to if the azimuth angle of said head-related function pair does not indicate a presence of a frontal source.

Embodiment 20: An apparatus according to embodiment 19,
wherein the rendering information processor (110) is configured to generate the at least one modification parameter for each head-related function pair of the one or more head-related function pairs by generating an offset value that depends on the elevation angle of said head-related function pair, if the azimuth angle of said head-related function pair indicates the presence of the frontal source.

Embodiment 21: An apparatus according to one of embodiments 5 to 20, further depending on embodiment 4,
wherein the one or more original head-related function pairs are a plurality of original head-related function pairs, wherein the direction information comprises different direction information for each of the plurality of head-related function pairs,
wherein the rendering information processor (110) is configured to modify the first original head-related function and/or the second original head-related function of each original head-related function pair of the plurality of original head-related function pairs depending on the direction information for said original head-related function pair to obtain a first modified head-related function and/or a second modified head-related function of each of the one or more modified head-related function pairs being a plurality modified head-related function pairs,
wherein the signal processor (120) is configured to process the one or more audio input signals depending on said at least one modified head-related function pair of the plurality of modified head-related function pairs to obtain the binaural signal.

Embodiment 22: An apparatus according to embodiment 21,
wherein the signal processor (120) is configured to process the one or more audio input signals depending on one or more interpolated head-related function pairs to obtain the binaural signal,
wherein the rendering information processor (110) is configured to determine the interpolated head-related function comprising a first interpolated head-related function and a second interpolated head-related function,
wherein the rendering information processor (110) is configured to determine, depending on the direction information, the first interpolated head-related function by interpolating between the first head-related function of each of at least two head-related function pairs of the plurality of head-related function pairs, and
wherein the rendering information processor (110) is configured to determine, depending on the direction information, the second interpolated head-related function by interpolating between the second head-related function of each of the at least two head-related function pairs of the plurality of head-related function pairs.

Embodiment 23: An apparatus according to one of the preceding embodiments,
wherein, for modifying, depending on the direction information, the original binaural rendering information to obtain the modified binaural rendering information in which the spectral distortion is adjusted, the rendering information processor (110) is configured to employ the following formula:

$$HRT {F}_{c o m p r e s s e d} ( az , ele , b ) = rms ( {HRTF}_{u n c o m p r e s s e d} ) ++ ( ( HRT {F}_{u n c o m p r e s s e d} ( az , ele , b ) - rms ( HRT {F}_{u n c o m p r e s s e d} ) ) \cdot \cdot compressionFactor ( az , ele , b ) )$$

wherein b denotes frequency bands,
wherein az denotes azimuth,
wherein ele denotes elevation,
wherein HRTF_{compressed} indicates a compressed HRTF,
wherein HRTF_{uncompressed} indicates an uncompressed HRTF,
wherein rms indicates root mean square.

Embodiment 24: A method, wherein the method comprises:
modifying, depending on direction information, original binaural rendering information to obtain modified binaural rendering information in which a spectral distortion is adjusted.

Embodiment 25: A computer program for implementing the method of embodiment 24
when being executed on a computer or signal processor.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### LITERATURE

[1] Merimaa, J.: “Modification of HRTF filters to reduce timbral effects in binaural synthesis”, In Audio Engineering Society Convention 127. Audio Engineering Society, 2009.
[2] Merimaa, J.: “Modification of HRTF filters to reduce timbral effects in binaural synthesis, part 2: Individual HRTFs”, In Audio Engineering Society Convention 129, 2010.
[3] Song Li: “On Externalization of Virtual Sound Images Presented via Headphones”, PhD Thesis University Hannover, 2021, (Experiment D).
[4] DE 10 2019 135 690 A1, Pellegrini, “Verfahren und Vorrichtung zur Audiosignalverarbeitung für binaurale Virtualisierung”.
[5] US 2021 0195361 A1, Pellegrini, “Method and device for audio signal processing for binaural virtualization”.
[6] Marentakis, G. and Hölzl, J.: “Compression Efficiency and Signal Distortion of Common PCA Bases for HRTF Modelling” 18th Sound and Music Computing Conference (SMC 2021), Virtual, 29 Jun.-1 Jul. 2021.
[7] Hölzl, J.: “An initial Investigation into HRTF Adaptation using PCA”.
[8] Lin Wang: “HRTF Compression via Principal Components Analysis and Vector Quantization”, 2008.
[9] Jing Wang: “Compression of Head-Related Transfer Function Based on Tucker and Tensor Train Decomposition”, 2019.

1. An apparatus, wherein the apparatus comprises:
a rendering information processor configured for modifying, depending on direction information, original binaural rendering information to acquire modified binaural rendering information in which a spectral distortion is adjusted.

2. An apparatus according to claim 1,
wherein the rendering information processor is configured to modify the original binaural rendering information such that a degree of an adjustment of the spectral distortion depends on the direction information.

3. An apparatus according to claim 1,
wherein the binaural rendering information is suitable for being used to process one or more audio input signals to acquire a binaural signal comprising two audio channels.

4. An apparatus according to claim 3,
wherein the apparatus further comprises a signal processor configured for processing the one or more audio input signals depending on the modified binaural rendering information to acquire the binaural signal comprising the two audio channels.

5. An apparatus according to claim 1,
wherein the original binaural rendering information comprises one or more original head-related function pairs, wherein each of the one or more original head-related function pairs comprises a first original head-related function and a second original head-related function,
wherein, depending on the direction information, the rendering information processor is configured to modify the first original head-related function and/or the second original head-related function of each of the one or more original head-related function pairs to acquire a first modified head-related function and/or a second modified head-related function of each of one or more modified head-related function pairs.

6. An apparatus according to claim 5,
wherein the rendering information processor is configured to determine a factor depending on a direction, and
wherein the rendering information processor is configured to apply the factor on the first original head-related function and/or on the second original head-related function of at least one of the one or more original head-related function pairs to acquire the first modified head-related function and/or the second modified head-related function of at least one of the one or more modified head-related function pairs.

7. An apparatus according to claim 6,
wherein the factor is a compression factor.

8. An apparatus according to claim 5,
wherein the rendering information processor is configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair is modified.

9. An apparatus according to claim 8,
wherein, if the direction information indicates that spectral distortion shall be reduced, the rendering information processor is configured to modify the first original head-related function and/or the second original head-related function of each original head-related function pair of the one or more head-related function pairs depending on the direction information such that at least one magnitude difference between two frequency bands of the first original head-related function and/or the second original head-related function of said original head-related function pair is reduced.

10. An apparatus according to claim 1,
wherein the rendering information processor is configured to modify the original binaural rendering information such that a degree of an adjustment of the spectral distortion depends on the direction information,
wherein the original binaural rendering information comprises one or more original head-related function pairs, wherein each of the one or more original head-related function pairs comprises a first original head-related function and a second original head-related function,
wherein, depending on the direction information, the rendering information processor is configured to modify the first original head-related function and/or the second original head-related function of each of the one or more original head-related function pairs to acquire a first modified head-related function and/or a second modified head-related function of each of one or more modified head-related function pairs,
wherein the direction information comprises direction information for each of the one or more head-related function pairs,
wherein the direction information for each of the one or more head-related function pairs comprises an elevation angle and/or an azimuth angle for said head-related function pair, and
wherein the rendering information processor is configured to modify the first original head-related function and/or the second original head-related function of said original head-related function pair depending on the elevation angle and/or depending on the azimuth angle for said head-related function pair.

11. An apparatus according to claim 10,
wherein the rendering information processor is configured to determine one or more modification parameters depending on the direction information,
wherein the rendering information processor is configured to modify the first original head-related function and/or the second original head-related function of each of the one or more original head-related function pairs depending on the at least one of the one or more modification parameters,
wherein each of the one or more modification parameters indicates the degree of the adjustment of the spectral distortion.

12. An apparatus according to claim 11,
wherein the rendering information processor is configured to determine the one or more modification parameters by determining at least one modification parameter of the one or more modification parameters for each of the one or more head-related function pairs depending on the elevation angle and/or depending on the azimuth angle for said head-related function pair,
wherein each of the modification parameter for said head-related function pair indicates the degree of the adjustment of the spectral distortion in the first modified head-related function and/or in the second modified head-related function of the modified head-related function pair compared to the spectral distortion in the first original head-related function and/or in the second original head-related function of the original head-related function pair,
wherein the rendering information processor is configured to generate the at least one modification parameter for each head-related function pair of the one or more head-related function pairs such that, if the azimuth angle of said head-related function pair indicates a presence of a frontal source, the modification parameter is generated in a different way for a same value of the elevation angle of said head-related function pair, compared to if the azimuth angle of said head-related function pair does not indicate a presence of a frontal source,
wherein the rendering information processor is configured to generate the at least one modification parameter for each head-related function pair of the one or more head-related function pairs by generating an offset value that depends on the elevation angle of said head-related function pair, if the azimuth angle of said head-related function pair indicates the presence of the frontal source.

13. An apparatus according to claim 1,
wherein, for modifying, depending on the direction information, the original binaural rendering information to acquire the modified binaural rendering information in which the spectral distortion is adjusted, the rendering information processor is configured to employ the following formula:
$$HRT {F}_{c o m p r e s s e d} ( az , ele , b ) = rms ( {HRTF}_{u n c o m p r e s s e d} ) ++ ( ( HRT {F}_{u n c o m p r e s s e d} ( az , ele , b ) - rms ( HRT {F}_{u n c o m p r e s s e d} ) ) \cdot \cdot compressionFactor ( az , ele , b ) )$$
wherein b denotes frequency bands,
wherein az denotes azimuth,
wherein ele denotes elevation,
wherein HRTF_{compressed} indicates a compressed HRTF,
wherein HRTF_{uncompressed} indicates an uncompressed HRTF,
wherein rms indicates root mean square.

14. A method, wherein the method comprises:
modifying, depending on direction information, original binaural rendering information to acquire modified binaural rendering information in which a spectral distortion is adjusted.

15. A non-transitory digital storage medium having a computer program stored thereon to perform the method comprising:
modifying, depending on direction information, original binaural rendering information to acquire modified binaural rendering information in which a spectral distortion is adjusted,
when said computer program is run by a computer.
